(19) United States
(12) Patent Application Publication
(10) Pub. No.: US 2012/0056897 A1
(43) Pub. Date: Mar. 8, 2012

(54) DISPLAY APPARATUS

(75) Inventor: Yoshiki Okamoto, Kanagawa (JP)

(73) Assignee: Sony Corporation, Tokyo (JP)

(21) Appl. No.: 13/218,649

(22) Filed: Aug. 26, 2011

(30) Foreign Application Priority Data
Sep. 2, 2010 (JP) 2010-196816

(51) Int. Cl. G09G 5/00

(52) U.S. Cl. 345/619

(57) ABSTRACT

A display apparatus includes a display unit in which sub-pixels are periodically arranged at a first sub-pixel pitch in a first direction of a screen, each pixel is formed by the plurality of sub-pixels, and a plurality of viewpoint images is displayed on a display surface; and a barrier unit in which transmissive sections having a first width in the first direction are periodically arranged. The first width is set to be approximated to a multiple m (where m=1, 2, . . . , N (where N is the number of plurality of viewpoint images)) of the first sub-pixel pitch.

### BACKGROUND

The present disclosure relates to a display apparatus, and more particularly, to a display apparatus in which a barrier separates an image oriented toward a plurality of viewpoints.

A display apparatus has been developed in which a barrier including transmissive sections spatially separates an image oriented toward a plurality of viewpoints, so that images different in the respective viewpoints can be viewed. In such a display apparatus, the observer can view a stereoscopic image with his or her naked eyes by setting the plurality of viewpoints including the positions of the right and left eyes of the observer and reflecting a predetermined parallax between the image oriented toward the viewpoint at the position of the right eye and the image oriented toward the viewpoint at the position of the left eye. The barrier used in the display apparatus is particularly called a parallax barrier. Further, the display apparatus using the parallax barrier can also display a planar image, for example, by reflecting no parallax to the images oriented toward the plurality of viewpoints, that is, by displaying the same image at the plurality of viewpoints.

In the display apparatus in which the images oriented toward the plurality of viewpoints are periodically arranged to be displayed, luminance unevenness called moire is generated. The moire is observed as a striped pattern in an image and thus may give a sense of discomfort to an observer. For this reason, techniques for reducing the moire observed in an image have been devised. For example, Japanese Patent No. 4023626 discloses a technique for reducing the moire by allowing a proportion of the transmissive sections to be larger than a normal proportion in the barrier. Further, Japanese Patent No. 3955002 discloses a technique for reducing the moire by forming the transmissive sections of the barrier in an inclined stripe shape so that the width of the transmissive section is identical to a horizontal pixel pitch.

### SUMMARY

In Japanese Patent No. 4023626, the proportion of the transmissive sections of the barrier is set to be 1.1 to 1.8 times the reciprocal of the number of viewpoints, but a process of deriving the proportion of the transmissive sections is not clarified. In Japanese Patent No. 3955002, the fact that the width of the transmissive section of the barrier is made to be identical to the horizontal pixel pitch is just described, but a process of deriving the width of the transmissive section is not described at all. The display apparatus has to be designed in consideration of various requirements as well as the reduction in the moire so as not to give a sense of discomfort or fatigue to an observer who views an image. Therefore, when attempts are made to reduce the moire by the above-mentioned techniques, a problem may arise in that flexibility in design of a display apparatus may deteriorate due to restriction on the configuration thereof.

It is desirable to provide a novel and improved display apparatus capable of reducing moire while ensuring flexibility in design in the configuration in which a barrier separates an image oriented toward a plurality of viewpoints.

According to an embodiment of the disclosure, there is provided a display apparatus including: a display unit in which sub-pixels are periodically arranged at a first sub-pixel pitch in a first direction of a screen, each pixel is formed by the plurality of sub-pixels, and a plurality of viewpoint images is displayed on a display surface; and a barrier unit in which transmissive sections having a first width in the first direction are periodically arranged. The first width is set to be approximated to a multiple m (where m=1, 2, . . . , N (where N is the number of plurality of viewpoint images)) of the first sub-pixel pitch.

With such a configuration, since the frequency component in which a beat occurs can be reduced in a spatial periodic structure in which the light intensity distribution of the sub-pixels is superimposed on the light intensity distribution of the transmissive sections, it is possible to reduce the moire observed in an image. Further, the width can be freely set to be near one of the plurality of values, thereby ensuring flexibility in design.

According to another embodiment of the disclosure, there is provided a display apparatus including: a display unit in which sub-pixels are periodically arranged at a first sub-pixel pitch in a first direction of a screen, each pixel is formed by the plurality of sub-pixels, and a plurality of viewpoint images is displayed on a display surface; and a barrier unit in which transmissive sections having a first width in the first direction are periodically arranged. The first width is set so that a function f (j) is approximated to 0 on the assumption that j is any integer, p_{S1} is the first sub-pixel pitch, w_{B1} is the first width, and α is a constant larger than 0,

$$f ( j ) = α \cdot \frac{sin ( \frac{{w}_{B 1}}{{p}_{S 1}} j π )}{j π} .$$

According to still another embodiment of the disclosure, there is provided a display apparatus including: a display unit in which sub-pixels are periodically arranged at a first sub-pixel pitch in a first direction of a screen and are periodically arranged at a second sub-pixel pitch in a second direction of the screen, each pixel is formed by the plurality of sub-pixels, and a plurality of viewpoint images is displayed on a display surface; and a barrier unit in which transmissive sections are periodically arranged with a first width in the first direction and are periodically arranged with a second width in the second direction. The first and second widths are set so that a function f(j,k) is approximated to 0 on the assumption that j and k are any integer, p_{S1} is the first sub-pixel pitch, p_{S2} is the second sub-pixel pitch, w_{B1} is the first width, w_{B2} is the second width, and β is a constant larger than 0,

$$f ( j , k ) = β \cdot \frac{sin ( \frac{{w}_{B 1}}{{p}_{S 1}} j π )}{j π} \cdot \frac{sin ( \frac{{w}_{B 2}}{{p}_{S 2}} k π )}{k π} .$$

The barrier unit may be disposed in front of the display surface of the display unit.

The display apparatus may further include a light source. The barrier section may be disposed between the light source and the display unit.

The sub-pixels may be periodically arranged at a second sub-pixel pitch in the second direction of the screen. The transmissive section may have a second barrier width in the second direction. The second width may be set to be approximated to a multiple n (where n=1, 2, . . . , N (where N is the number of plurality of viewpoint images)) of the second sub-pixel pitch.

The first direction may be a horizontal direction of the screen. The second direction may be a vertical direction of the screen. The barrier unit may be a step barrier in which the transmissive sections are arranged in a step shape.

The first width may be a multiple m of the first sub-pixel pitch. The second width may be a multiple n of the second sub-pixel pitch.

The barrier unit may be an inclined stripe barrier. The first direction may be perpendicular to an extension direction of the transmissive section.

The first width may be a multiple m of the first sub-pixel pitch.

A pixel opening section, which is an opening section of one of the plurality of sub-pixels forming each pixel, may have a first pixel opening width in the first direction.

The first pixel opening width may be set to be approximated to the first sub-pixel pitch.

A pixel opening section, which is an opening section of one of the plurality of sub-pixels forming each pixel, may have a second pixel opening width in a second direction of the screen. The sub-pixels may be periodically arranged at a second sub-pixel pitch in the second direction. The second pixel opening width may be set to be approximated to the second sub-pixel pitch.

According to the embodiments of the disclosure, the display apparatus in which the barrier separates the image oriented toward the plurality of viewpoints can reduce the moire while ensuring the flexibility in design.

### BRIEF DESCRIPTION OF THE DRAWINGS

FIG. 1 is a diagram illustrating the overall configuration of a display apparatus according to a first embodiment of the disclosure;

FIG. 2 is a schematic elevational view illustrating a display and a parallax barrier according to the first embodiment of the disclosure, when viewed from the side;

FIG. 3 is a diagram illustrating a pixel opening section according to the first embodiment of the disclosure;

FIG. 4 is a diagram illustrating a light intensity distribution of the display according to the first embodiment of the disclosure;

FIG. 5 is a diagram illustrating a transmission section according to the first embodiment of the disclosure;

FIG. 6 is a diagram illustrating a light intensity distribution of a parallax barrier according to the first embodiment of the disclosure;

FIG. 7 is a diagram illustrating a frequency spectrum of the light intensity distribution according to the first embodiment of the disclosure;

FIG. 8 is a diagram illustrating superposition between the frequency spectra of the light intensity distributions according to the first embodiment of the disclosure;

FIG. 9 is a diagram illustrating a combination of the frequencies of the light intensities in first and second directions according to the first embodiment of the disclosure;

FIG. 10 is a diagram illustrating a distance between the display and the parallax barrier according to the second embodiment of the disclosure when viewed from the viewpoint;

FIG. 11 is a diagram illustrating a width according to the second embodiment of the disclosure; and

FIG. 12 is a diagram illustrating a combination of the frequencies of the light intensities in first and second directions according to the second embodiment of the disclosure.

### DETAILED DESCRIPTION OF EMBODIMENTS

Hereinafter, preferred embodiments of the disclosure will be described in detail with reference to the accompanying drawings. Throughout the specification and the drawings, the same reference numerals are given to constituent elements having substantially the same function and the description thereof will not be repeated.

The description will be made in the following order.

1. First Embodiment

1-1. Configuration of Display Apparatus

1-2. Light Intensity Distribution in Image

1-3. Cause of Generation of Moire

1-4. Design for Reducing Moire

2. Second Embodiment

2-1. Configuration of Display Apparatus

2-2. Light Intensity Distribution in Image

2-3. Cause of Generation of Moire

2-4. Design for Reducing Moire

3. Supplement

### 1. First Embodiment

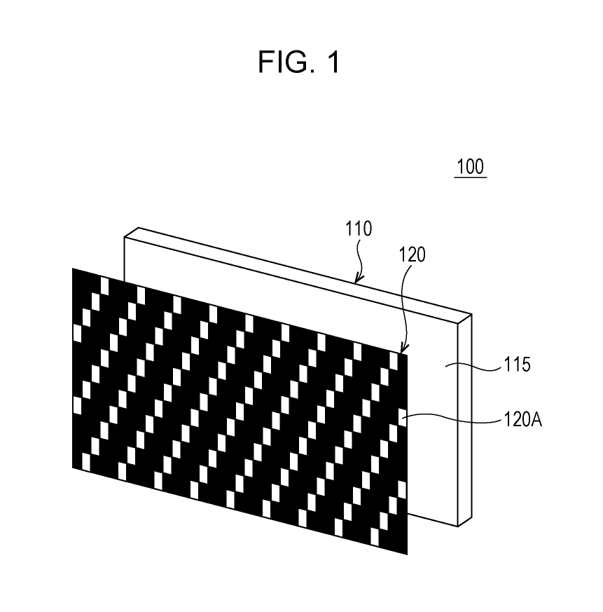

First, a first embodiment of the disclosure will be described with reference to FIGS. 1 to 9.

### 1-1. Configuration of Display Apparatus

FIG. 1 is a diagram illustrating the overall configuration of a display apparatus 100 according to a first embodiment of the disclosure. As shown in FIG. 1, the display apparatus 100 includes a display 110 and a parallax barrier 120.

The display 110 is a display unit that displays N viewpoint images respectively oriented toward N viewpoints (where N is any plural number) using pixels having three sub-pixels. For example, the display 110 may be an LCD (Liquid Crystal Display), a PDP (Plasma Display Panel), an organic EL (Electro-Luminescence) panel, or the like.

The parallax barrier 120 is disposed in front of a display surface 115 of the display 110 or between a backlight of the display 110 and the display surface 115 at a predetermined interval. The parallax barrier 120 includes transmissive sections 120A formed in a step shape in an inclination direction. The parallax barrier 120 transmits light from the display 110 through the transmissive sections 120A and blocks the light in the other portions. The transmissive sections 120A are arranged so as to conform with the arrangement of the image oriented toward the N viewpoints displayed in the display 110, so that the parallax barrier 120 separates the image oriented toward the N viewpoints for the viewpoint images, respectively.

Here, the parallax barrier 120 may be realized by displaying an image higher in the transmittance of light in portions corresponding to the transmissive sections 120A than in the other portions by the use of a transmissive liquid crystal display device. In this case, the transmissive sections 120A may not necessarily be physical opening sections. The transmittance of the light in the transmissive section 120A may not necessarily be 100% and may be higher than that the other portions.

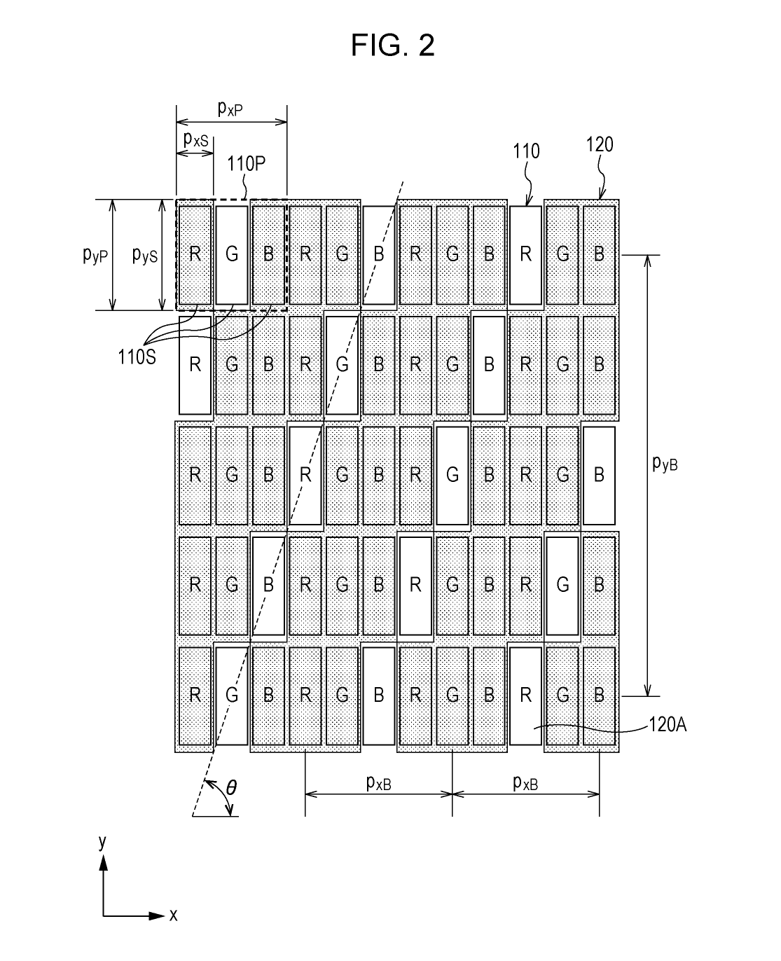

FIG. 2 is a schematic elevational view illustrating the display 110 and the parallax barrier 120 according to the first embodiment of the disclosure, when viewed from the side of the viewpoint. In the display 110, as shown in FIG. 2, sub-pixels 110S are periodically arranged. In this embodiment, a pixel 110P includes three sub-pixels 110S. The number of sub-pixels of the pixel may be plural and the embodiment of the disclosure is not limited to 3. In the parallax barrier 120, the transmissive sections 120A are periodically arranged. In this embodiment, the number of viewpoints N is 4.

The sub-pixels 110S are arranged at a first sub-pixel pitch p_{xS} in an x-axis direction, which is a first direction of a screen, and are arranged at a second sub-pixel pitch p_{yS} in a y-axis direction, which is a second direction of the screen. The sub-pixels 110S displaying three colors of R (red), G (green), and B (blue) are periodically arranged in the order of R, G, and B in the x-axis direction. The sub-pixels 110S displaying one of the three colors of R, G, and B are periodically arranged in the y-axis direction.

The pixel 110P includes three sub-pixels 110S displaying three colors of R, G, and B, respectively. The pixels 110P are arranged at a first pixel pitch p_{xP} in the x-axis direction and are arranged at a second pixel pitch p_{yP} in the y-axis direction. Here, since the pixel 110P includes the three sub-pixels 110S arranged in the x-axis direction, the first pixel pitch p_{xP} and the first sub-pixel pitch p_{xS} satisfy a relationship expressed by Expression (1).

$${p}_{x S} = \frac{{p}_{x P}}{3} \qquad ( 1 )$$

Further, the second pixel pitch p_{yP} and the second sub-pixel pitch p_{yP} satisfy a relationship expressed by Expression (2).

p_{yS}=p_{yP} (2)

The transmissive sections 120A are periodically arranged in the parallax barrier 120 and have a substantially similar shape to that of the sub-pixel 110S. In the first embodiment, the parallax barrier 120 is a kind of barrier called a step barrier, in which the transmissive sections 120A with a step shape are arranged in the inclination direction of an angle θ. The transmissive sections 120A are arranged at a first barrier pitch p_{xB} in the x-axis direction and are arranged at a second barrier pitch p_{yB} in the y-axis direction.

Here, in the display 110, the image is separated oriented toward the N viewpoints and each image oriented toward a single viewpoint is displayed in the sub-pixel 110S arranged in the inclination direction of the angle θ. That is, the image oriented toward the first viewpoint, the image oriented toward the second viewpoint, . . . , and the image oriented toward the N-th viewpoint are repeatedly arranged in sequence in the unit of the sub-pixel 110S arranged in the inclination direction of the angle θ. Accordingly, the first barrier pitch p_{xB}, the first sub-pixel pitch p_{xS}, and the first pixel pitch p_{xP} satisfy a relationship expressed by Expression (3).

$${p}_{x B} = N \cdot {p}_{x S} \dot{=} N \cdot \frac{{p}_{x P}}{3} \qquad ( 3 )$$

Further, the second barrier pitch p_{yB}, the second sub-pixel pitch p_{yS}, and the second pixel pitch p_{yP} satisfy a relationship expressed by Expression (4).

P_{yB}=N·p_{yS}=N·p_{yP} (4)

The angle θ is determined by a ratio between the x-axis direction and the y-axis direction of the sub-pixel 110S. For example, when the first pixel pitch p_{xP} and the second pixel pitch p_{yP} are the same as each other, a relationship expressed by Expression (5) is satisfied.

θ=arctan 3 (5)

### 1-2. Light Intensity Distribution in Image Light Intensity Distribution of Display

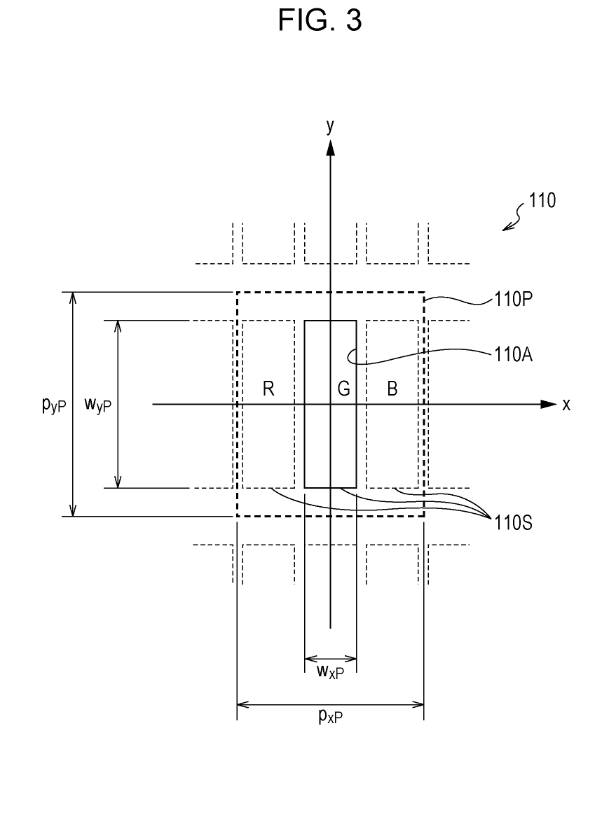

FIG. 3 is a diagram illustrating a pixel opening section 110A according to the first embodiment of the disclosure. As shown in FIG. 3, the pixel opening section 110A is an opening section of one of the plurality of sub-pixels 110S that form the pixel 110P.

The pixel opening section 110A is a light-transmitting section of the pixel 110P for one of the three colors of R, G, and B. In the example shown in the drawing, G (green) light-transmitting section of the pixel 110P is set as the pixel opening section 110A. In this case, the pixel opening section 110A serves as an opening section of the sub-pixel 110S that displays G (green) light. The pixel opening section 110A has a first pixel opening width w_{xP} in the x-axis direction and a second pixel opening width w_{yP} in the y-axis direction.

Likewise, the same pixel opening section 110A exists in the pixel 110P (not shown) adjacent to the pixel 110P shown in the drawing. Accordingly, in the display 110, the interval of the pixel opening sections 110A in the x-axis direction is the same as the first pixel pitch p_{xP} and the interval of the pixel opening sections 110A in the y-axis direction is the same as the second pixel pitch p_{yP}.

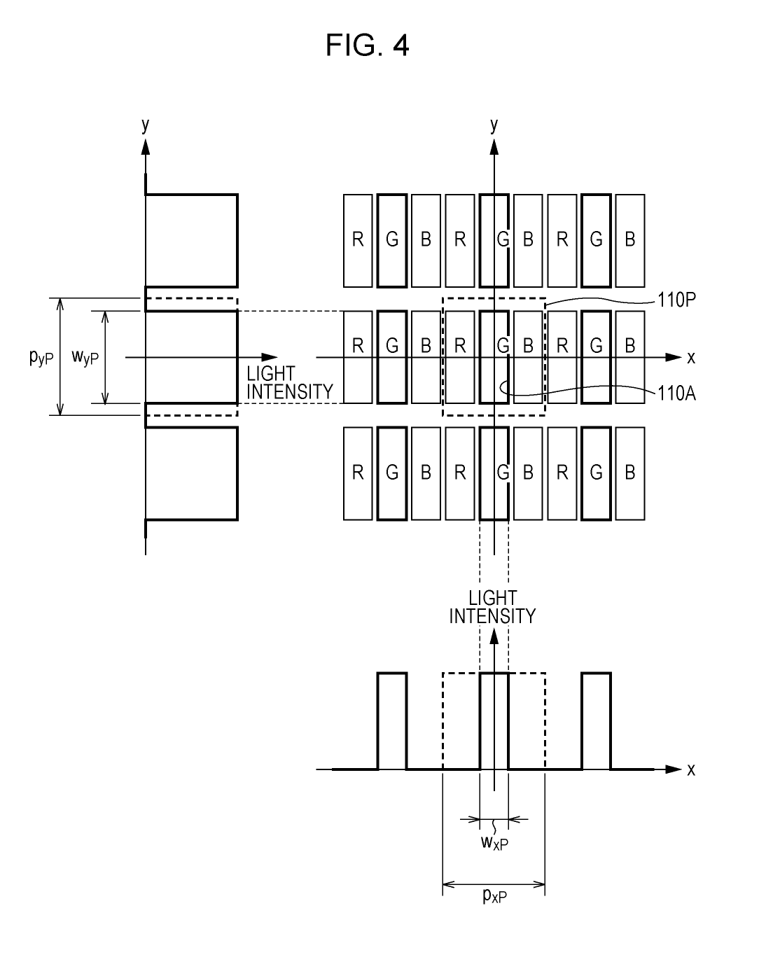

FIG. 4 is a diagram illustrating a light intensity distribution of the display 110 according to the first embodiment of the disclosure. As shown in FIG. 4, the G (green) light intensity in the display 110 is distributed periodically in the x-axis and y-axis directions.

The display 110 emits the G (green) light in the pixel opening sections 110A which are the G (green) light-transmitting sections of the pixels 110P. As shown in the drawing, the pixels 110P are arranged at the first pixel pitch p_{xP} in the x-axis direction and are arranged at the second pixel pitch p_{yP} in the y-axis direction. In each pixel 110P, the pixel opening section 110A has a first pixel opening width w_{xP} in the x-axis direction and has a second pixel opening width w_{yP} in the y-axis direction.

Accordingly, the light intensity distribution of the display 110 has a pulse-shaped periodic structure with a period p_{xP} and a width w_{xP} in the x-axis direction. Further, the light intensity distribution has a pulse-shaped periodic structure with a period p_{yP} and a width w_{yP} in the y-axis direction. The light intensity observed with the two-dimensional periodic structure is expressed as a function f_{P}(x,y) for the x and y coordinates using the Fourier series by Expression (6). In this expression, m and n denote the series order and aₘₙ, aₘ, and aₙ denote Fourier coefficients.

$$\begin{matrix}{f}_{P} ( x , y ) = {\sum }_{m = - ∞}^{∞} {\sum }_{n = - ∞}^{∞} {a}_{mn} \cdot exp [ - i2π ( \frac{m}{{p}_{x P}} x + \frac{n}{{p}_{y P}} y ) ] \\ = {\sum }_{m = - ∞}^{∞} {a}_{m} \cdot exp [ - i 2 π \frac{m}{{p}_{x P}} x ] \cdot {\sum }_{n = - ∞}^{∞} {a}_{n} \cdot exp [ - i2 π \frac{n}{{p}_{y P}} y ]\end{matrix} \qquad ( 6 )$$

### Light Intensity Distribution by Parallax Barrier

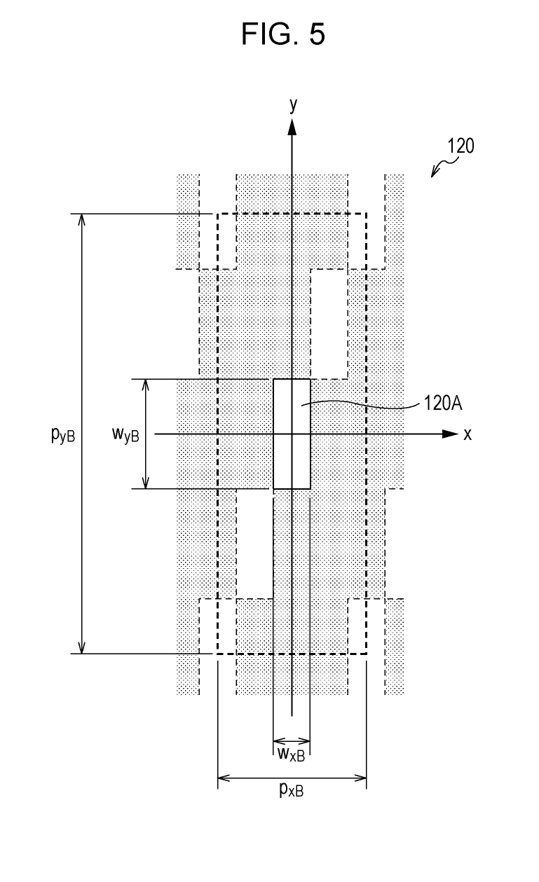

FIG. 5 is a diagram illustrating the transmissive section 120A according to the first embodiment of the disclosure. As shown in FIG. 5, the transmissive sections 120A are periodically arranged in the parallax barrier 120.

The transmissive section 120A has a first width w_{xB} in the x-axis direction and has a second width w_{yB} in the y-axis direction. As shown in FIG. 2, the transmissive sections 120A are arranged at the first barrier pitch p_{xB} in the x-direction and are arranged at the second barrier pitch p_{yB} in the y-axis direction.

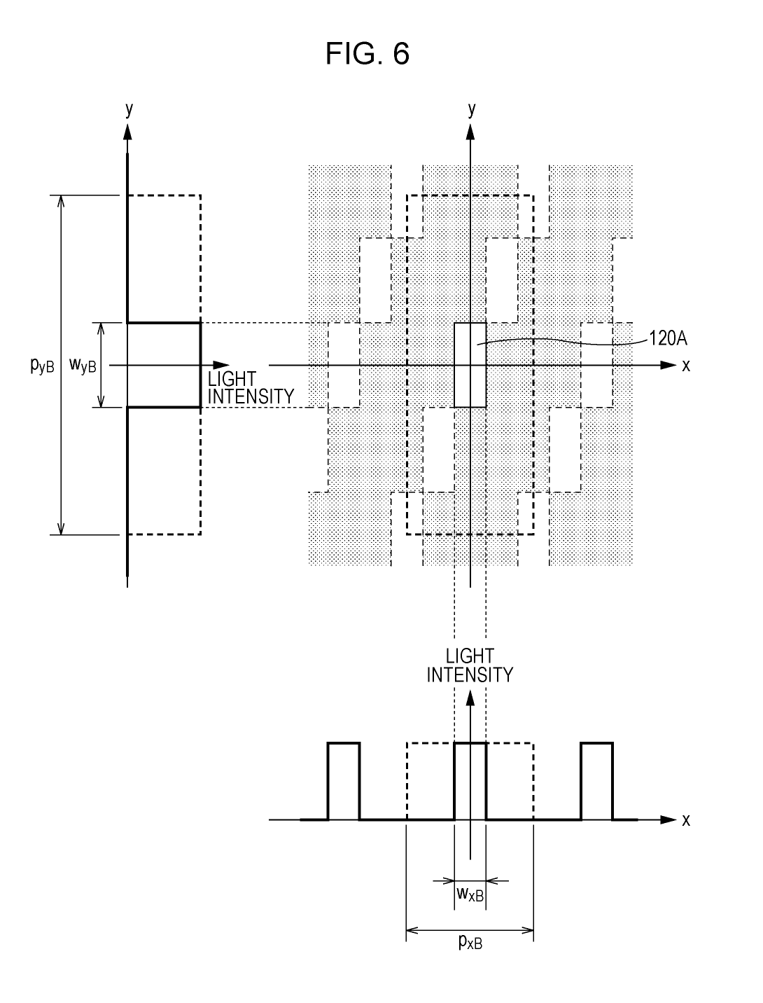

FIG. 6 is a diagram illustrating the light intensity distribution of a parallax barrier 120 according to the first embodiment of the disclosure. As shown in FIG. 6, the light intensity in the parallax barrier 120 is distributed periodically in the x-axis and y-axis directions.

In the parallax barrier 120, the transmissive sections 120A pass through the light from the display 110. As shown in the drawing, the transmissive sections 120A are arranged at the first barrier pitch p_{xB} in the x-axis direction and are arranged at the second barrier pitch p_{yB} in the y-axis direction. Further, the transmissive section 120A has a first width w_{xB} in the x-axis direction and has a second width w_{yB} in the y-axis direction.

Accordingly, the light intensity distribution of the parallax barrier 120 has a pulse-shaped periodic structure with a period p_{xB} and a width w_{xB} in the x-axis direction. Further, the light intensity distribution has a pulse-shaped periodic structure with a period p_{yB} and a width w_{yS} in the y-axis direction. The light intensity observed with the two-dimensional periodic structure is expressed as a function f_{B}(x,y) for the x and y coordinates using the Fourier series by Expression (7). In this expression, m and n denote the series order and bₘₙ, bₘ, and bₙ denote Fourier coefficients.

$$\begin{matrix}{f}_{B} ( x , y ) = {\sum }_{m = - ∞}^{∞} {\sum }_{n = - ∞}^{∞} {b}_{mn} \cdot exp [ - i2π ( \frac{m}{{p}_{x B}} x + \frac{n}{{p}_{y B}} y ) ] \\ = {\sum }_{m = - ∞}^{∞} {b}_{m} \cdot exp [ - i 2 π \frac{m}{{p}_{x B}} x ] \cdot {\sum }_{n = - ∞}^{∞} {b}_{n} \cdot exp [ - i2 π \frac{n}{{p}_{y B}} y ]\end{matrix} \qquad ( 7 )$$

### Light Intensity Distribution Observed in Image

The light intensity observed in an image displayed by the display apparatus 100 according to the first embodiment of the disclosure is a light intensity that is formed by superimposing the light intensity in the display 110 on the light intensity in the parallax barrier 120, as described above. The light intensity formed by the superimposing is expressed by a product of the functions representing the respective light intensities. Accordingly, the light intensity distribution observed in the image is expressed by a product of the function f_{P}(x,y) of Expression (6) representing the light intensity in the display 110 and the function f_{B}(x,y) of Expression (7) representing the light intensity in the parallax barrier 120, as in Expression (8).

$$\begin{matrix}{f}_{P} ( x , y ) \cdot {f}_{B} ( x , y ) = {\sum }_{m = - ∞}^{∞} {\sum }_{n = - ∞}^{∞} {a}_{mn} \cdot exp [ - i2π ( \frac{m}{{p}_{x P}} x + \frac{n}{{p}_{y P}} y ) ] \cdot \\ {\sum }_{m = - ∞}^{∞} {\sum }_{n = - ∞}^{∞} {b}_{mn} \cdot exp [ - i2π ( \frac{m}{{p}_{x B}} x + \frac{n}{{p}_{y B}} y ) ] \\ = {\sum }_{m = - ∞}^{∞} {a}_{m} \cdot exp [ - i 2 π \frac{m}{{p}_{x P}} x ] \cdot \\ {\sum }_{n = - ∞}^{∞} {a}_{n} \cdot exp [ - i2 π \frac{n}{{p}_{y P}} y ] \cdot \\ {\sum }_{m = - ∞}^{∞} {b}_{m} \cdot exp [ - i2 π \frac{m}{{p}_{x B}} x ] \cdot \\ {\sum }_{n = - ∞}^{∞} {b}_{n} \cdot exp [ - i2 π \frac{n}{{p}_{y B}} y ]\end{matrix} \qquad ( 8 )$$

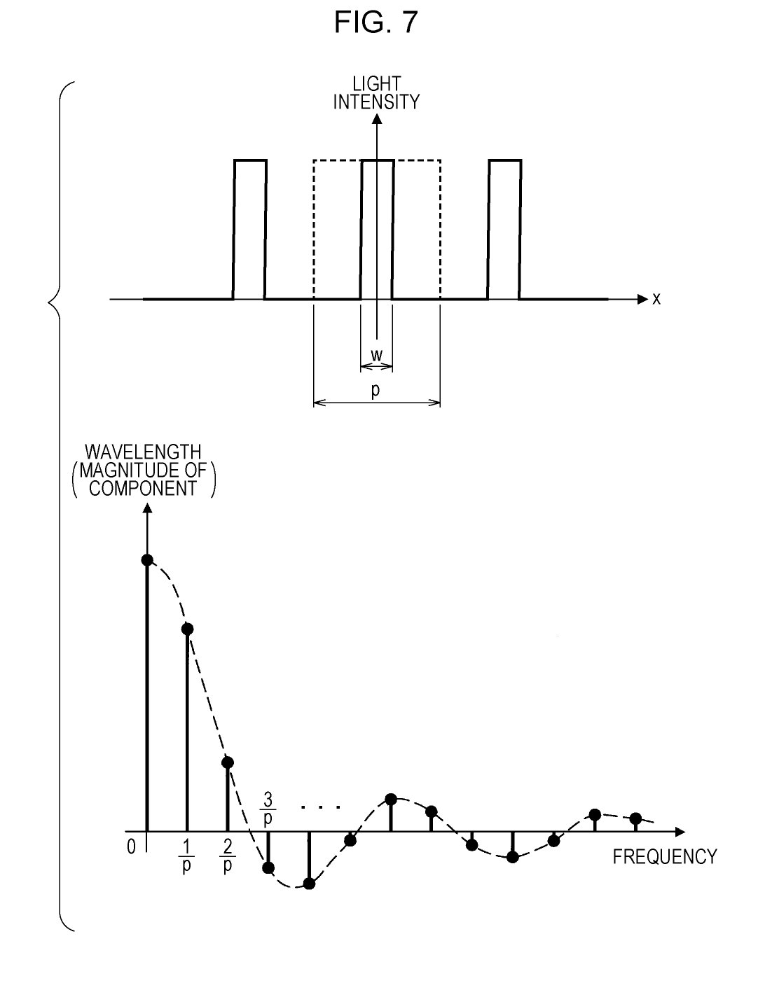

FIG. 7 is a diagram illustrating a frequency spectrum of the light intensity distribution according to the first embodiment of the disclosure. As shown in FIG. 7, the light intensity having a pulse-shaped periodic structure with a period p and a width w has a discrete spectrum with an interval of 1/p.

The envelope line of the discrete spectrum of a function having a pulse-shaped periodic structure becomes a sinc function. When the envelope line of the discrete spectrum is applied to the function f_{P}(x,y) of Expression (6) representing the light intensity of the display 110, a Fourier coefficient of the product form of the sinc function is calculated as in Expression (9).

$${a}_{mn} = {a}_{m} \cdot {a}_{n} \frac{sin ( \frac{{w}_{x P}}{{p}_{x P}} m π )}{m π} \frac{sin ( \frac{{w}_{y P}}{{p}_{y P}} n π )}{n π} . \qquad ( 9 )$$

Likewise, when the envelope line is applied to the function f_{B}(x,y) of Expression (7) representing the light intensity in the parallax barrier 120, a Fourier coefficient in which a coefficient is applied to the sinc function is calculated, as in Expression (10), when j is any integer.

$${b}_{mn} = \frac{sin ( \frac{{w}_{x B}}{{p}_{x B}} m π )}{m π} \frac{sin ( \frac{{w}_{y B}}{{p}_{y B}} n π )}{n π} \cdot {\sum }_{j = 1}^{\frac{N}{2}} 2 cos [ \frac{2 j - 1}{N} ( m + n ) π ] ( N = EVEN NUMBER ) \\ {b}_{mn} = \frac{sin ( \frac{{w}_{x B}}{{p}_{x B}} m π )}{m π} \frac{sin ( \frac{{w}_{y B}}{{p}_{y B}} n π )}{n π} \cdot \{ 1 + {\sum }_{j = 1}^{\frac{N - 1}{2}} 2 cos [ \frac{2 j}{N} ( m + n ) π ] \} ( N = ODD NUMBER ) \qquad ( 10 )$$

Expression (10) is established, when w_{xB}≦p_{yB}/N and w_{yB}≦p_{yB}/N. In other cases, the product portion of the sinc function is the same even when the coefficient portion is varied.

### 1-3. Cause of Generation of Moire

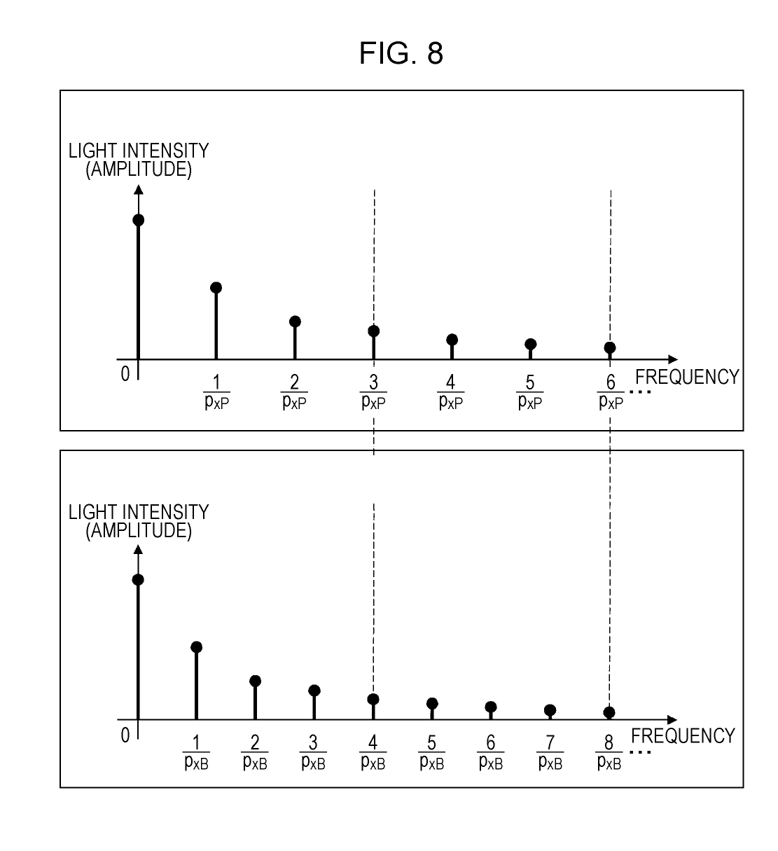

FIG. 8 is a diagram illustrating the superposition between the frequency spectra of the light intensity distributions according to the first embodiment of the disclosure. The frequency spectrum of the light intensity distribution of the display 110 is shown in the x axis direction in the upper part of FIG. 8. The frequency spectrum of the light intensity distribution of the parallax barrier 120 is shown in the x axis direction in the lower part of FIG. 8.

As described above, the light intensity distribution having the pulse-shaped periodic structure has a discrete spectrum with the reciprocal of a periodic interval. The light intensity distribution of the display 110 shown in the upper side of the drawing has a discrete spectrum of an interval of 1/p_{xP}. Likewise, the light intensity distribution of the parallax barrier 120 shown in the lower side of the drawing has a discrete spectrum of an interval of 1/p_{xB}.

Here, a cause of generation of moire will be described. The moire is generated as luminance unevenness caused by beat (buzz) between frequency components when frequency components slightly different from each other in frequency are contained in the frequency component of each of the superimposed light intensity distributions when the plurality of light intensity distributions are superimposed on each other. The magnitude of the luminance unevenness depends on a product of the amplitudes (magnitude of light intensity) of the respective frequency components in which the beat occurs.

Accordingly, when the amplitude (light intensity) of the frequency component in which the beat occurs is large, the large luminance unevenness is generated, thereby observing the strong moire. Since the actual values of the first pixel pitch p_{xP} and the first barrier pitch p_{xB} depend on the mechanical processing accuracy and may have a small error, there is a high possibility of the moire being generated in the frequency component commonly contained in the respective light intensity distributions calculated by a value in terms of a design.

A condition for the frequency component commonly contained in the respective light intensity distributions of the display 110 and the parallax barrier 120 in the x-axis direction is expressed by Expression (11), when Expression (3) is used.

$$\frac{N}{{p}_{x B}} = \frac{3}{{p}_{x P}} \qquad ( 11 )$$

In this embodiment, since the number of viewpoints N is 4, a relationship of “4/p_{xB}=3/p_{xP}” is satisfied. Accordingly, in the example shown in FIG. 8, the components satisfying the above condition include the component with the frequency of 3/p_{xP} in the frequency component of the display 110, the component with the frequency of 4/p_{xB} in the frequency component of the parallax barrier 120, the component with the frequency of 6/p_{xP} in the frequency component of the display 110, and the component with the frequency of 8/p_{xB} in the frequency component of the parallax barrier 120.

The case in which the x-axis direction is used has hitherto been described, but the same relationship is applied to the y-axis direction, which is the second direction. A condition for the frequency component commonly contained in the respective light intensity distributions of the display 110 and the parallax barrier 120 in the y-axis direction is expressed by Expression (12), when Expression (4) is used.

$$\frac{N}{{p}_{y B}} = \frac{1}{{p}_{yP}} \qquad ( 12 )$$

A condition that the moire is generated in the observed image is expressed by Expression (13) from Expression (11) and Expression (12), when s and t are any integers.

$$( s \frac{N}{{p}_{xB}} , t \frac{N}{{p}_{yB}} ) = ( s \frac{3}{{p}_{xP}} , t \frac{1}{{p}_{yP}} ) \qquad ( 13 )$$

In this embodiment, N is 4 in Expression (12) and Expression (13), as described above.

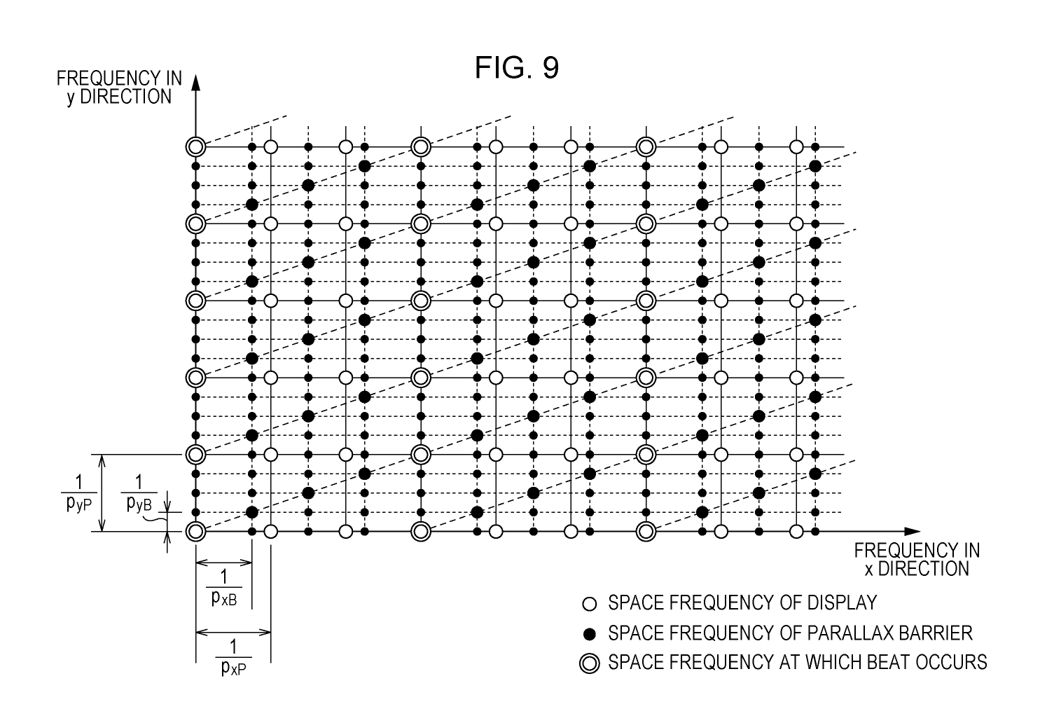

FIG. 9 is a diagram illustrating a combination of the frequencies of the light intensities in the x-axis direction, which is the first direction, and y-axis direction, which is the second direction, according to the first embodiment of the disclosure. As shown in FIG. 9, the combination of the space frequencies of the light intensity distribution of the display 110 and the light intensity distribution of the parallax barrier 120 in the x-axis and y-axis directions is plotted.

The frequency distribution shown here is a frequency distribution formed by combining the frequency distributions described with reference to FIG. 8 in the x-axis and y-axis directions. Accordingly, the combination of the frequency components commonly contained in the light intensity distribution of the display 110 and the light intensity distribution of the parallax barrier 120 in the x-axis and y-axis directions is shown as a combination of the frequency components in which the beat occurs. Here, the frequency at which the beat (moire) occurs appears at an equal interval in the xy space due to the periodicity of the light intensity distribution of the display 110 and the periodicity of the light intensity distribution of the parallax barrier 120.

### 1-4. Design for Reducing Moire

As expressed in Expression (8), the light intensity observed in the image is expressed by the product of the light intensity of the display 110 and the light intensity of the parallax barrier 120. Accordingly, when one of the light intensities approaches 0 in the combination of the frequency components at which the moire is generated, it is possible to reduce the moire.

First, when the Fourier coefficient expressed by Expression (9) becomes 0 in the light intensity distribution of the display 110, the light intensity (amplitude) of the frequency at which the moire is generated can be made to approach 0, thereby preventing the moire from being generated. The condition that the Fourier coefficient becomes 0 is expressed by Expression (14), when j is any integer.

$$\frac{sin ( \frac{{w}_{xP}}{{p}_{xP}} 3 j π )}{3 j π} = 0 OR \frac{sin ( \frac{{w}_{yP}}{{p}_{yP}} )}{j π} = 0 \qquad ( 14 )$$

The above condition is expressed by Expression (15) from Expression (1) and Expression (2). In this condition, since the first pixel opening width w_{xP}, is not greater than the first sub-pixel pitch p_{xS} and the second pixel opening width w_{yP} is not greater than the second sub-pixel pitch p_{yS}, the condition of Expression (14) is restricted to a case where j=1.

w_{xP}=p_{xS} OR w_{yP}=q_{yS} (15)

Furthermore, the condition that the Fourier coefficient expressed by Expression (10) becomes 0 in the light intensity distribution of the parallax barrier 120 is expressed by Expression (16), when j is any integer.

$$\frac{sin ( \frac{{w}_{xB}}{{p}_{xB}} jN π )}{jN π} = 0 OR \frac{sin ( \frac{{w}_{yB}}{{p}_{yB}} jN π )}{jN π} = 0 \qquad ( 16 )$$

The above condition is expressed by Expression (17) from Expression (3) and Expression (4). In this condition, since the first width w_{xB} is not greater than the first barrier pitch p_{xB} and the second width w_{yB} is not greater than the second barrier pitch p_{yB}, j is 1, 2, . . . , N. That is, j is a natural number equal to or less than the number of viewpoints N.

$$\frac{{w}_{xB}}{{P}_{xS}} = j OR \frac{{w}_{yB}}{{p}_{ys}} = j \qquad ( 17 )$$

When the conditions expressed by Expression (15) for the display 110 and Expression (17) for the parallax barrier 120 are summarized, one of the following conditions may be satisfied in order to reduce the moire observed in the image displayed by the display apparatus 100.

(a) A ratio of the first width w_{xB} to the first sub-pixel pitch p_{xS} is a natural number equal to or less than N.

(b) A ratio of the second width w_{yB} to the second sub-pixel pitch p_{yS} is a natural number equal to or less than N.

(c) The first pixel opening width w_{xP} is identical to the first sub-pixel pitch p_{xS}.

(d) The second pixel opening width w_{yP} is identical to the second sub-pixel pitch p_{yS}.

In the actual design of the display apparatus 100, it is difficult to precisely satisfy the above-mentioned conditions since there is a necessity to form a space for a driving circuit between the sub-pixels 1105. However, by designing the display apparatus so as to approximate the above-mentioned conditions, the moire can be reduced to some extent. In this case, by designing the display apparatus so as to satisfy a number of the conditions (a) to (d), the product of four Fourier coefficients shown in Expression (8) has a smaller value, thereby further reducing the moire.

### 2. Second Embodiment

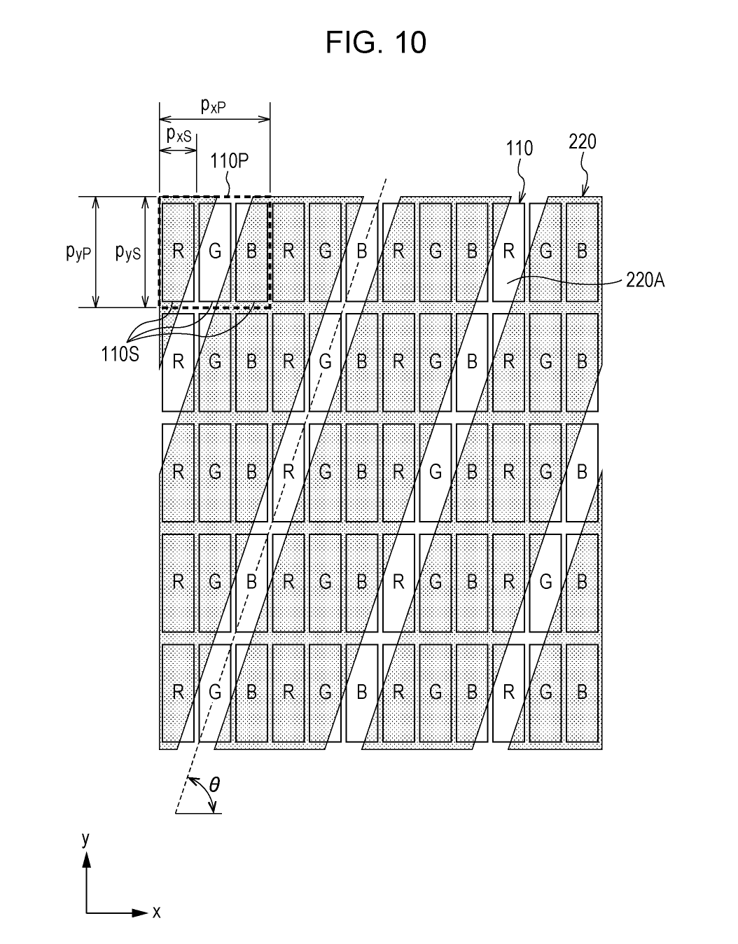

Next, a second embodiment of the disclosure will be described with reference to FIGS. 10 to 12. The second embodiment of the disclosure is different from the first embodiment in the configuration of the parallax barrier 120. However, since the remaining configuration is the same as that of the first embodiment, the detailed description thereof will not be repeated.

### 2-1. Configuration of Display Apparatus

FIG. 10 is a schematic elevational view illustrating the display 110 and the parallax barrier 220 according to the second embodiment of the disclosure, when viewed from the side of the viewpoint. In the display 110, as shown in FIG. 10, sub-pixels 1105 are periodically arranged. In this embodiment, a pixel 110P is formed by three sub-pixels 110S. The number of sub-pixels of the pixel may be plural and the embodiment of the disclosure is not limited to 3. In a parallax barrier 220, transmissive sections 220A are periodically arranged. In this embodiment, the number of viewpoints N is 4.

The transmissive sections 220A are periodically arranged in the parallax barrier 220 and have a stripe shape. In the second embodiment, the parallax barrier 220 is a kind of barrier called a stripe barrier, in which the transmissive sections 220A are arranged in the inclination direction of an angle θ. The barrier pitch of the transmissive section 220A will be described below.

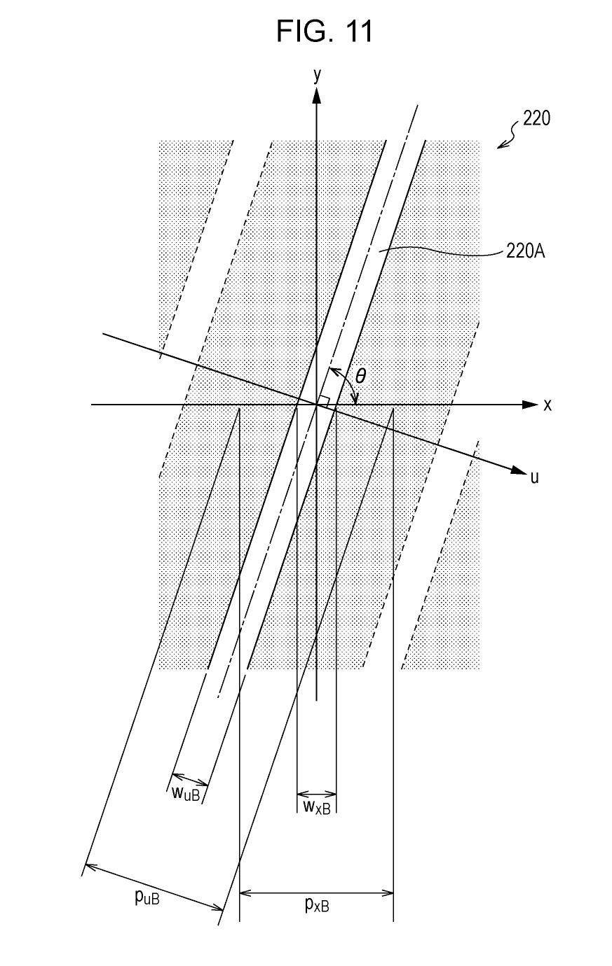

FIG. 11 is a diagram illustrating the transmissive section 220A according to the second embodiment of the disclosure. As shown in FIG. 11, the transmissive sections 220A are periodically arranged in the parallax barrier 220.

The transmissive section 220A has a stripe shape extending in the inclination direction of the angle θ with respect to the x axis. Here, a u axis is set in a direction perpendicular to the extension direction of the transmissive section 220A. The relationships between a distance u in the u-axis direction and the x and y coordinates are expressed by Expression (18).

x=u cos θ

y=u sin θ (18)

The transmissive section 220A has a width w_{uB} in the u-axis direction. Further, the transmissive sections 220A are arranged at a barrier pitch p_{uB} in the u-axis direction. Hereinafter, the light intensity distribution in the u-axis direction in the parallax barrier 220 will be described. In the transmissive section 220A, a width w_{xB} in the x-axis direction and the barrier pitch p_{xB} in the x-axis direction may be defined as in Expression (19).

w_{xB}=w_{uB} cos θ

p_{xB}=p_{uB} cos θ (19)

Although not illustrated, a width w_{yB} in the y-axis direction and a barrier pitch p_{yB} in the y-axis direction can also be defined, as in Expression (20).

w_{yB}=w_{uB} sin θ

p_{yB}=p_{uB} sin θ (20)

### 2-2. Light Intensity Distribution in Image

As in the light intensity distribution of the parallax barrier 120 described with reference to FIG. 6 in the first embodiment, the light intensity distribution of the parallax barrier 220 has a pulse-shaped periodic structure with a period p_{uB} and a width w_{uB} in the u-axis direction. The light intensity observed with periodic structure is expressed as a function f_{B}(u) for the distance u in the u-axis direction using a Fourier series, as in Expression (21). In this expression, m denotes the series order and bₘ denotes a Fourier coefficient.

$${f}_{B} ( u ) = {\sum }_{m = - ∞}^{∞} {b}_{m} \cdot exp [ - i2π \frac{m}{{p}_{uB}} u ] \qquad ( 21 )$$

The light intensity observed in an image displayed by the display apparatus 100 according to the second embodiment of the disclosure is a light intensity that is formed by superimposing the light intensity in the display 110 on the light intensity in the parallax barrier 220. The light intensity formed by the superimposing is expressed by a product of the functions representing the respective light intensities. Accordingly, the light intensity distribution observed in the image is expressed by a product of the function f_{P}(x,y) of Expression (6) representing the light intensity in the display 110 of the first embodiment and the function f_{B}(u) of Expression (21) representing the light intensity in the parallax barrier 220, as in Expression (22).

$$\begin{matrix}{f}_{P} ( x , y ) \cdot {f}_{B} ( u ) = {\sum }_{m = - ∞}^{∞} {\sum }_{n = - ∞}^{∞} {a}_{mn} \cdot exp [ - i2π ( \frac{m}{{p}_{xP}} x + \frac{n}{{p}_{yP}} y ) ] \cdot \\ {\sum }_{m = - ∞}^{∞} {b}_{m} \cdot exp [ - i2π \frac{m}{{p}_{uB}} u ] \\ = {\sum }_{m = - ∞}^{∞} {a}_{m} \cdot exp [ - i2π \frac{m}{{p}_{xP}} x ] \cdot \\ {\sum }_{n = - ∞}^{∞} {a}_{n} \cdot exp [ - i2π \frac{n}{{p}_{yP}} y ] \cdot \\ {\sum }_{m = - ∞}^{∞} {b}_{m} \cdot exp [ - i2π \frac{m}{{p}_{uB}} u ]\end{matrix} \qquad ( 22 )$$

The envelope line of the discrete spectrum of a function having a pulse-shaped periodic structure has a sinc function. Therefore, when the envelope line of the discrete spectrum is applied to the function f_{B}(u) of Expression (21) representing the light intensity of the parallax barrier 220, a Fourier coefficient of the form of the sinc function is calculated as in Expression (23).

$${b}_{m} = \frac{sin ( \frac{{w}_{uB}}{{p}_{uB}} m π )}{m π} \qquad ( 23 )$$

### 2-3. Cause of Generation of Moire

Here, the light intensity distribution of the parallax barrier 220 has a discrete spectrum of an interval of 1/p_{uB} in the u-axis direction. The light intensity distribution is decomposed in the x-axis and y-axis directions in the consideration of the superimposition with the light intensity distribution of the display 110. The light intensity distribution of the parallax barrier 220 in the x-axis direction has a discrete spectrum with an interval of 1/p_{uB} cos θ from Expression (19).

As described with reference to FIG. 8 in the first embodiment, there is a high possibility of the moire being generated in the frequency component commonly contained in the light intensity distributions of the display 110 and the parallax barrier 220. This condition is expressed for the x-axis direction by Expression (24) by the use of Expression (3).

$$\frac{N}{{p}_{uB} cos θ} = \frac{3}{{p}_{xP}} \qquad ( 24 )$$

This condition is expressed for the y-axis direction by Expression (25) by the use of Expression (4).

$$\frac{N}{{p}_{uB} sin θ} = \frac{1}{{p}_{yP}} \qquad ( 25 )$$

In this expression, on the assumption that p_{xS} is the first sub-pixel pitch in the x-axis direction and p_{yS} is the second sub-pixel pitch in the y-axis direction, the sub-pixel pitch p_{uS} in the u-axis direction is defined as in Expression (26).

$${p}_{uS} = \frac{{p}_{xS}}{cos θ} = \frac{{p}_{yS}}{sin θ} \qquad ( 26 )$$

When Expression (24) and Expression (25) are summarized in the u-axis direction using Expression (26), the condition that the moire is generated in the observed image is expressed by Expression (27) on the assumption that s is any integer.

$$s \frac{N}{{p}_{uB}} = s \frac{1}{{p}_{uS}} \qquad ( 27 )$$

In this embodiment, N is 4 in Expression (24), Expression (25), and Expression (27), as described above.

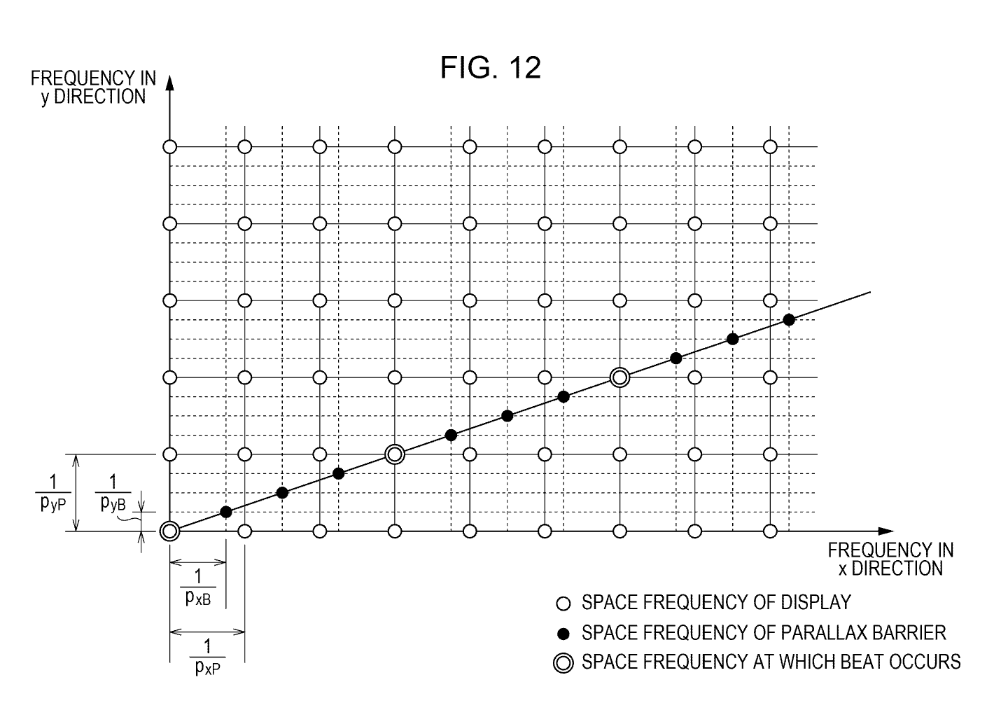

FIG. 12 is a diagram illustrating a combination of the frequencies of the light intensities in the x-axis direction, which is the first direction, and y-axis direction, which is the second direction, according to the second embodiment of the disclosure. As shown in FIG. 12, the combination of the space frequencies of the light intensity distribution of the display 110 and the light intensity distribution of the parallax barrier 220 in the x-axis and y-axis directions is plotted.

The frequency distribution shown here is a frequency distribution formed by combining the frequency distributions described with reference to FIG. 8 in the first embodiment in the x-axis and y-axis directions from Expression (24), Expression (25), and Expression (27). Accordingly, the combination of the frequency components commonly contained in the light intensity distribution of the display 110 and the light intensity distribution of the parallax barrier 220 in the x-axis and y-axis directions is shown as a combination of the frequency components in which the beat occurs. Here, the frequency at which the beat (moire) occurs appears at an equal interval in the xy space due to the periodicity of the light intensity distribution of the display 110 and the periodicity of the light intensity distribution of the parallax barrier 220.

### 2-4. Design for Reducing Moire

As expressed in Expression (22), the light intensity observed in the image is expressed by the product of the light intensity of the display 110 and the light intensity of the parallax barrier 220. Accordingly, when one of the light intensities approaches 0 in the combination of the frequency components at which the moire is generated, it is possible to reduce the moire.

First, when the Fourier coefficient expressed by Expression (23) becomes 0 in the light intensity distribution of the parallax barrier 220, the light intensity (amplitude) of the frequency at which the moire is generated can be made to approach 0, thereby preventing the moire from being generated. The condition that the Fourier coefficient becomes 0 is expressed by Expression (28), when j is any integer.

$$\frac{sin ( \frac{{w}_{uB}}{{p}_{uB}} j π )}{j π} = 0 \qquad ( 28 )$$

The above condition is expressed by Expression (29) for the u-axis direction. In this expression, the width w_{uB} is not greater than the barrier pitch p_{uB}; j is 1, 2, . . . , N. That is, j is a natural number equal to or less than the number of viewpoints N.

$$\frac{{p}_{uB}}{{p}_{uS}} = j \qquad ( 29 )$$

When the condition expressed by Expression (15) for the display 110 and Expression (29) for the parallax barrier 220 is summarized, one of the following conditions may be satisfied in order to reduce the moire observed in the image displayed by the display apparatus 100.

(a) A ratio of the width w_{uB} to the sub-pixel pitch p_{uS} is a natural number equal to or less than N.

(b) The first pixel opening width w_{xP} is identical to the first sub-pixel pitch p_{xS}.

(c) The second pixel opening width w_{yP} is identical to the second sub-pixel pitch p_{yS}.

In the actual design of the display apparatus 100, it is difficult to precisely satisfy the above-mentioned conditions since there is a necessity to form a space for a driving circuit between the sub-pixels 110S. However, by designing the display apparatus so as to approximate the above-mentioned conditions, the moire can be reduced to some extent. In this case, by designing the display apparatus so as to satisfy a number of the conditions (a) to (c), the product of three Fourier coefficients shown in Expression (22) has a smaller value, thereby further reducing the moire.

### 3. Supplement

The preferred embodiments of the disclosure have hitherto been described with reference to the accompanying drawings, but the disclosure is not limited to the embodiments. It should be apparent to those skilled in the art that various modifications and alterations may occur within the scope of the appended claims or the equivalents thereof and it should be understood that the modifications and alterations, of course, pertain to the technical scope of the disclosure.

The present disclosure contains subject matter related to that disclosed in Japanese Priority Patent Application JP 2010-196816 filed in the Japan Patent Office on Sep. 2, 2010, the entire contents of which are hereby incorporated by reference.

1. A display apparatus comprising:
a display unit in which a plurality of sub-pixels are periodically arranged at a first sub-pixel pitch in a first direction of a screen, each pixel is formed by the plurality of sub-pixels, and a plurality of viewpoint images is displayed on a display surface; and
a barrier unit in which transmissive sections having a first width in the first direction are periodically arranged,
wherein the first width is set to be approximated to a multiple of the first sub-pixel pitch.

2. A display apparatus comprising:
a display unit in which a plurality of sub-pixels are periodically arranged at a first sub-pixel pitch in a first direction of a screen, each pixel is formed by the plurality of sub-pixels, and a plurality of viewpoint images is displayed on a display surface; and
a barrier unit in which transmissive sections having a first width in the first direction are periodically arranged,
wherein the first width is set so that a function f (j) is approximated to 0 on an assumption that j is any integer, p_{S1} is the first sub-pixel pitch, w_{B1} is the first width, and α is a constant larger than 0, wherein
$$f ( j ) = α \cdot \frac{sin ( \frac{{w}_{B 1}}{{p}_{S 1}} j π )}{j π} .$$

3. A display apparatus comprising:
a display unit in which a plurality of sub-pixels are periodically arranged at a first sub-pixel pitch in a first direction of a screen and are periodically arranged at a second sub-pixel pitch in a second direction of the screen, each pixel is formed by the plurality of sub-pixels, and a plurality of viewpoint images is displayed on a display surface; and
a barrier unit in which transmissive sections are periodically arranged with a first width in the first direction and are periodically arranged with a second width in the second direction,
wherein the first and second widths are set so that a function f(j,k) is approximated to 0 on an assumption that j and k are any integer, p_{S1} is the first sub-pixel pitch, p_{S2} is the second sub-pixel pitch, w_{B1} is the first width, w_{B2} is the second width, and β is a constant larger than 0, wherein
$$f ( j , k ) = β \cdot \frac{sin ( \frac{{w}_{B 1}}{{p}_{S 1}} j π )}{j π} \cdot \frac{sin ( \frac{{w}_{B 2}}{{p}_{S 2}} k π )}{k π} .$$

4. The display apparatus according to claim 1, wherein the barrier section is disposed in front of the display surface of the display unit.

5. The display apparatus according to claim 1, further comprising:
a light source,
wherein the barrier section is disposed between the light source and the display unit.

6. The display apparatus according to claim 1,
wherein the sub-pixels are periodically arranged at a second sub-pixel pitch in the second direction of the screen,
wherein the transmissive section has a second barrier width in the second direction, and
wherein the second width is set to be approximated to a multiple of the second sub-pixel pitch.

7. The display apparatus according to claim 6,
wherein the first direction is a horizontal direction of the screen,
wherein the second direction is a vertical direction of the screen, and
wherein the barrier unit is a step barrier in which the transmissive sections are arranged in a step shape.

8. The display apparatus according to claim 7,
wherein the first width is a multiple of the first sub-pixel pitch, and
wherein the second width is a multiple of the second sub-pixel pitch.

9. The display apparatus according to claim 1,
wherein the barrier unit is an inclined stripe barrier, and
wherein the first direction is perpendicular to an extension direction of the transmissive sections.

10. The display apparatus according to claim 9, wherein the first width is a multiple of the first sub-pixel pitch.

11. The display apparatus according to claim 1,
wherein a pixel opening section, which is an opening section of one of the plurality of sub-pixels forming each pixel, has a first pixel opening width in the first direction, and
wherein the first pixel opening width is set to be approximated to the first sub-pixel pitch.

12. The display apparatus according to claim 1,
wherein a pixel opening section, which is an opening section of one of the plurality of sub-pixels forming each pixel, has a second pixel opening width in a second direction of the screen,
wherein the sub-pixels are periodically arranged at a second sub-pixel pitch in the second direction, and
wherein the second pixel opening width is set to be approximated to the second sub-pixel pitch.
